(19) United States
(12) Patent Application Publication
(10) Pub. No.: US 2021/0126235 A1
(43) Pub. Date: Apr. 29, 2021

(54) METHOD FOR PREPARATION OF COATING MATERIAL FOR TERNARY LITHIUM BATTERY

(71) Applicant: NiveauUp INC., Wilmington, DE (US)

(72) Inventor: Biing-Jiun Perng, Taipei City (TW)

(21) Appl. No.: 16/666,764

(22) Filed: Oct. 29, 2019

(51) Int. Cl. H01M 4/04; H01M 4/62; H01M 4/131; H01M 4/1391

(52) U.S. Cl. CPC H01M 4/0404; H01M 4/621; H01M 10/0525; H01M 4/1391; H01M 4/131

(57) ABSTRACT

A method for preparation of a coating material for a ternary lithium battery is disclosed herein. The coating material is prepared by an active material, a conductive material and an adhesive and can be coated on a positive electrode or a negative electrode of the ternary lithium battery to form plural ring-shaped three-dimensional structures and effectively increase the capacitance. Furthermore, the coating material prepared by aluminum oxide (Al₂O₃) can be coated on an isolation film or a positive electrode to improve heat resistance of the ternary lithium battery.

### BACKGROUND OF THE INVENTION

### 1. Field of the Invention

The present invention relates to a method for preparation of a coating material for a ternary lithium battery which can be coated on a positive electrode or a negative electrode film of the ternary lithium battery to form ring-shaped three-dimensional structures for increasing the capacitance, or coated on an isolation film or a positive electrode for improving heat resistance of the ternary lithium battery, thereby effectively assisting in the development of automotive batteries.

### 2. Description of Related Art

Lithium-ion battery is a rechargeable battery that uses lithium compounds as the electrode material. Due to its unique properties, it has been widely used in a variety of consumer electronics. For instance, mobile devices, tablets and other mobile devices use lithium-ion batteries as a source of electricity. Furthermore, with the shortage of energy and the trend of environmental protection, the techniques of electric vehicles has also improved in recent years. In addition to the emerging electric vehicle brands, various traditional vehicle manufacturers also actively develop pure electric vehicles to provide more options of non-fuel vehicles for consumers. The power source of the electric vehicle is mainly provided by the motor and the battery. The electric vehicle industry generally uses ternary lithium-ion batteries, referred to as ternary lithium batteries. As the demand for electric vehicles increases, the demand for ternary lithium batteries also increases.

A conventional ternary lithium battery mainly comprises a positive electrode, a negative electrode, an isolation film and an electrolyte. However, the conventional ternary lithium battery has three disadvantages:

(1) A layer of slurry coated on the positive and negative electrodes is easily aggregated as shown in FIG. 12 since it is prepared by directly mixing an active material, a conductive material and an adhesive. For instance, the U.S. Pat. No. 9,257,696B2, issued on Feb. 9, 2016, has disclosed a positive electrode mixture slurry for lithium secondary batteries, and a positive electrode and a lithium battery that use said slurry. The phenomenon of aggregation causes poor uniformity and poor settlement stability of the slurry and leads to low capacitance.

(2) The isolation film is easily melted because the temperature of the conventional ternary lithium battery rises during use. Furthermore, melting of the isolation film causes the positive electrode to contact the negative electrode, resulting in a short circuit and even an explosion.

(3) The conventional ternary lithium battery has low charge and discharge efficiency, poor performance at high magnification, and short cycle life.

### SUMMARY OF THE INVENTION

In view of the above-mentioned problems, the object of the present invention is to provide a method for preparation of a coating material for a ternary lithium battery which comprises mixing an active material and a conductive material to form a three-dimensional structure having plural rings to prevent aggregation and aluminum oxide (Al₂O₃) to improve heat resistance of an isolation film of the ternary lithium battery, thereby improving safety and service life of the ternary lithium battery.

A first embodiment for the method for preparation of a coating material for a ternary lithium battery is disclosed herein. It comprises the steps of: (a) preparing a dry powder by mixing 80-99 wt % of an active material and 1-20 wt % of a conductive material at a first speed for a first period of time, and preparing a binder solution by mixing 5-20 wt % of an adhesive and 80-95 wt % of a solvent at the first speed for the first period of time; (b) mixing the dry powder and the binder solution at a second speed to form a mixed solution; (c) placing the mixed solution in a vacuum container for a second period of time; and (d) nano-dispersing the mixed solution to obtain the coating material.

According to an embodiment of the present invention, the active material is selected from lithium cobaltate (LiCoO₂), nickel cobalt oxide or manganese cobalt oxide, and the conductive material is carbon black.

According to an embodiment of the present invention, the adhesive is resin, and the solvent is selected from alcohol, acetone or toluene.

According to an embodiment of the present invention, the second period of time ranges from 15 minutes to 1 hour.

According to an embodiment of the present invention, the mixed solution in the step (b) is prepared by: mixing about 16.7 volume percent of the dry powder with 25 volume percent of the adhesive at the second speed for the first period of time to form a first temporary mixture; mixing the first temporary mixture with about 16.7 volume percent of the dry powder at the second speed for the first period of time to form a second temporary mixture; mixing the second temporary mixture with 25 volume percent of the binder solution at the second speed for a third period of time to form a third temporary mixture; mixing the third temporary mixture with about 16.7 volume percent of the dry powder at the second speed for the first period of time to form a fourth temporary mixture; mixing the fourth temporary mixture with about 16.7 volume percent of the dry powder at the second speed for the first period of time to form a fifth temporary mixture; mixing the fifth temporary mixture with 25 volume percent of the binder solution at the second speed for the third period of time to form a sixth temporary mixture; mixing the sixth temporary mixture with about 16.7 volume percent of the dry powder at the second speed for the first period of time to form a seventh temporary mixture; mixing the seventh temporary mixture with about 16.7 volume percent of the dry powder at the second speed for the first period of time to form an eighth temporary mixture; and mixing the eighth temporary mixture with 25 volume percent of the binder solution at the second speed for the third period of time to obtain the mixed solution.

According to an embodiment of the present invention, the first speed and the second speed are 50 rpm-200 rpm and 1000 rpm-2000 rpm, respectively, and the first period of time and the second period of time respectively range from 30 minutes to 2 hours and from 1 hour to 4 hours.

A second embodiment for the method for preparation of a coating material for a ternary lithium battery is also disclosed herein. It comprises the steps of: (a) preparing a dry powder by mixing 80-99 wt % of an active material and 1-20 wt % of a conductive material at a first speed for a first period of time, and preparing a binder solution by mixing 5-20 wt % of an adhesive and 80-95 wt % of a solvent at the first speed for the first period of time; (b) mixing the dry powder and the binder solution to form a mixed solution; (c) placing the mixed solution in a vacuum container for a second period of time; and (d) stirring the mixed solution at a second speed to obtain the coating material.

According to an embodiment of the present invention, the active material is selected from lithium cobaltate (LiCoO₂), nickel cobalt oxide or manganese cobalt oxide, and the conductive material is carbon black.

According to an embodiment of the present invention, the adhesive is resin.

According to an embodiment of the present invention, the solvent is selected from alcohol, acetone or toluene, the first speed and the second speed are 50 rpm-2000 rpm and 1000 rpm-2000 rpm, respectively, and the first period of time and the second period of time respectively range from 1 hour to 4 hours and from 30 minutes to 2 hours.

A third embodiment for the method for preparation of a coating material for a ternary lithium battery is also disclosed herein. It comprises the steps of: (a) mixing an aluminium oxide (Al₂O₃), an adhesive, a surfactant with a deionized water, and performing nano-dispersion at room temperature for a first period of time to form a first temporary mixture; (b) ultrasonic stirring the first temporary mixture for a second period of time to form a mixed solution; and (c) ball milling the mixed solution at a first speed for a third period of time to obtain the coating material.

According to an embodiment of the present invention, the step (a) is mixing 35-40 wt % of the aluminium oxide (Al₂O₃), 0.1-1 wt % of the adhesive, 0.1-1 wt % of the surfactant with the remaining weight percent of the deionized water.

According to an embodiment of the present invention, the surfactant is disodium laureth sulfosuccinate (DLSS).

According to an embodiment of the present invention, the first speed is 200 rpm-500 rpm, and the first period of time, the second period of time and the third period of time respectively range from 30 minutes to 2 hours, from 12 hours to 24 hours and from 2 hours to 3 hours.

According to an embodiment of the present invention, the coating material is coated on an isolation film of the ternary lithium battery, dried at a first temperature for the first period of time, and further vacuum dried at the first temperature for a fourth period of time.

According to an embodiment of the present invention, the first temperature is 60-120° C., and the fourth period of time ranges from 24 hours to 48 hours.

A fourth embodiment for the method for preparation of a coating material for a ternary lithium battery is also disclosed herein. It comprises the steps of: (a) adding an aluminium oxide (Al₂O₃) into a solvent, and performing nano-dispersion for a first period of time to form a first temporary mixture; (b) ultrasonic stirring the first temporary mixture for a second period of time to form a second temporary mixture; (c) adding an active material into the second temporary mixture to form a third temporary mixture; (d) nano-dispersing the third temporary mixture for the first period of time to form a fourth temporary mixture; (e) ultrasonic stirring the fourth temporary mixture for a third period of time to form a fifth temporary mixture; (f) evaporating the fifth temporary mixture at a first temperature for the third period of time to obtain a mixed solution; and (g) calcining the mixed solution at a second temperature for the second period of time to obtain the coating material.

According to an embodiment of the present invention, the solvent is selected from alcohol, acetone or toluene, and the active material is selected from lithium cobaltate (LiCoO₂), nickel cobalt oxide or manganese cobalt oxide.

According to an embodiment of the present invention, the first temperature and the second temperature are 60-70° C. and 400-500° C., respectively, and the first period of time, the second period of time and the third period of time respectively range from 30 minutes to 2 hours, from 8 hours to 12 hours and from 12 hours to 24 hours.

According to an embodiment of the present invention, the first temporary mixture comprises 1-5 wt % of the aluminium oxide, and the third temporary mixture comprises 90-99.75 wt % of the active material and 0.25-10 wt % of the second temporary mixture.

### BRIEF DESCRIPTION OF THE DRAWINGS

The technical means adopted by the present invention to achieve the above and other objects can be best understood by referring to the following detailed description of the preferred embodiments and the accompanying drawings, wherein:

FIG. 1 is a schematic diagram showing a ternary lithium battery according to the present invention;

FIG. 2 is a flow chart showing a first embodiment for a method for preparation of a coating material for a ternary lithium battery according to the present invention;

FIG. 3 is a flow chart for preparing a mixed solution according to the present invention;

FIG. 4 is a flow chart showing a second embodiment for a method for preparation of a coating material for a ternary lithium battery according to the present invention;

FIG. 5 is a flow chart showing a third embodiment for a method for preparation of a coating material for a ternary lithium battery according to the present invention;

FIG. 6 is a flow chart showing a fourth embodiment for a method for preparation of a coating material for a ternary lithium battery according to the present invention;

FIG. 7 is a first schematic diagram showing a coating material in use according to the present invention;

FIG. 8 is a second schematic diagram showing a coating material in use according to the present invention;

FIG. 9 is an electron microscopic diagram showing a coating material according to the present invention;

FIG. 10 shows a comparison of charging energy between a conventional battery and a ternary lithium battery coated with the coating material of the present invention;

FIG. 11 shows a comparison of charging time between a conventional battery and a ternary lithium battery coated with the coating material of the present invention;

FIG. 12 is a schematic diagram showing slurry aggregation of a prior art.

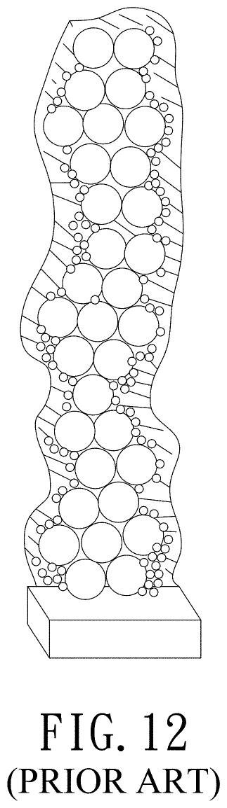

### DETAILED DESCRIPTION OF THE PREFERRED EMBODIMENT

Hereinafter, an exemplary embodiment of the present invention will be described in detail with reference to the accompanying drawings.

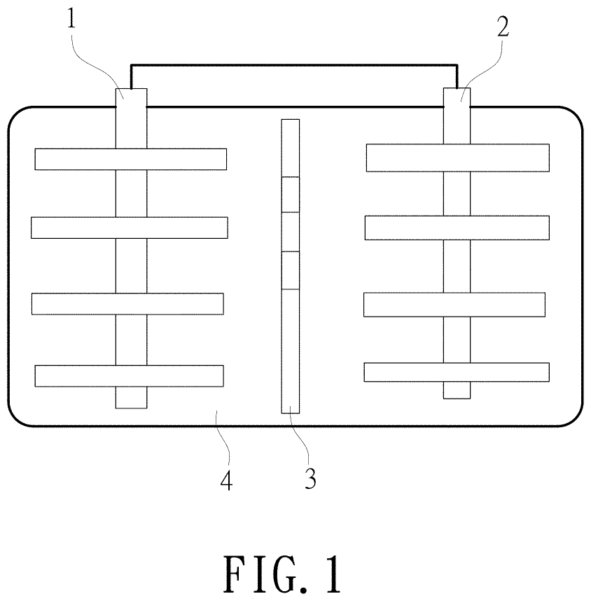

As showed in FIG. 1, a coating material prepared by the present method is used in a ternary lithium battery comprising a positive electrode (1), a negative electrode (2), an isolation film (3) and an electrolyte (4).

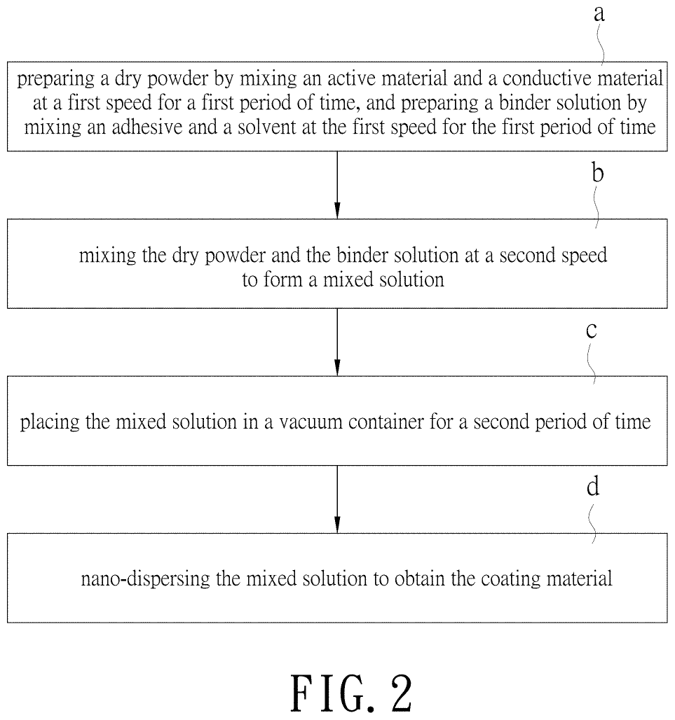

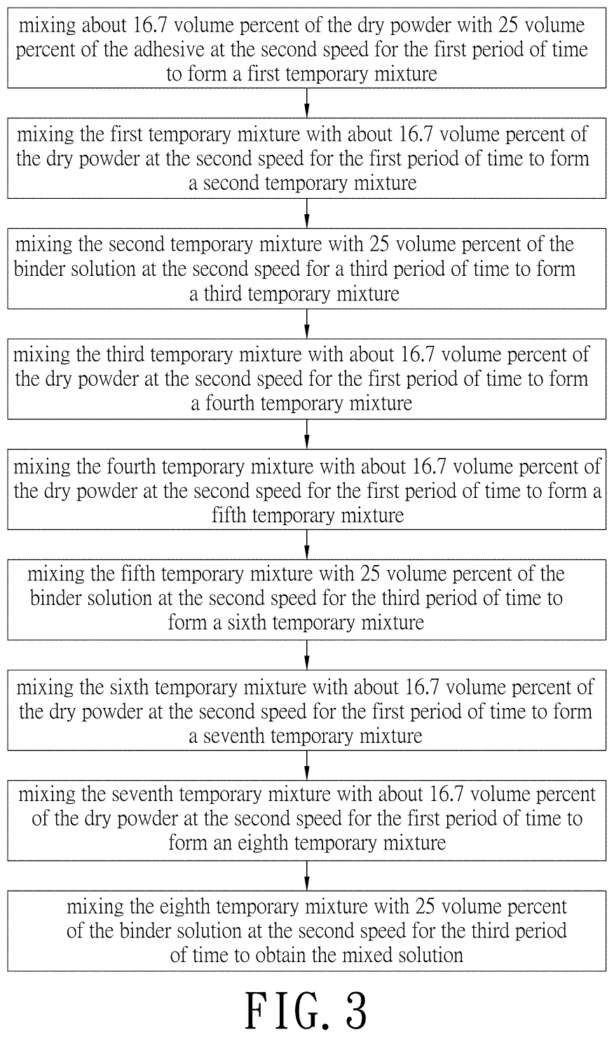

Referring to FIG. 2 and FIG. 3, a flow chart showing a first embodiment for a method for preparation of a coating material for a ternary lithium battery according to the present invention and a flow chart for preparing a mixed solution according to the present invention are respectively disclosed herein. The method for preparation of a coating material for a ternary lithium battery comprises the steps of:

(a) preparing a dry powder by mixing 80-99 wt % of an active material and 1-20 wt % of a conductive material at a first speed for a first period of time, and preparing a binder solution by mixing 5-20 wt % of an adhesive and 80-95 wt % of a solvent at the first speed for the first period of time; preferably, the active material is selected from lithium cobaltate (LiCoO₂), nickel cobalt oxide or manganese cobalt oxide, the conductive material is carbon black, the adhesive is resin, and the solvent is selected from alcohol, acetone or toluene;

(b) mixing the dry powder and the binder solution at a second speed to form a mixed solution;

(c) placing the mixed solution in a vacuum container for a second period of time; and

(d) nano-dispersing the mixed solution to obtain the coating material.

Preferably, the mixed solution in the step (b) is prepared by: mixing about 16.7 volume percent of the dry powder with 25 volume percent of the adhesive at the second speed for the first period of time to form a first temporary mixture; mixing the first temporary mixture with about 16.7 volume percent of the dry powder at the second speed for the first period of time to form a second temporary mixture; mixing the second temporary mixture with 25 volume percent of the binder solution at the second speed for a third period of time to form a third temporary mixture; mixing the third temporary mixture with about 16.7 volume percent of the dry powder at the second speed for the first period of time to form a fourth temporary mixture; mixing the fourth temporary mixture with about 16.7 volume percent of the dry powder at the second speed for the first period of time to form a fifth temporary mixture; mixing the fifth temporary mixture with 25 volume percent of the binder solution at the second speed for the third period of time to form a sixth temporary mixture; mixing the sixth temporary mixture with about 16.7 volume percent of the dry powder at the second speed for the first period of time to form a seventh temporary mixture; mixing the seventh temporary mixture with about 16.7 volume percent of the dry powder at the second speed for the first period of time to form an eighth temporary mixture; and mixing the eighth temporary mixture with 25 volume percent of the binder solution at the second speed for the third period of time so as to obtain the mixed solution. Preferably, the first speed is 50 rpm-200 rpm and the second speed is 1000 rpm-2000 rpm. Preferably, the first period of time, the second period of time, and the third period of time respectively range from 30 minutes to 2 hours, 15 minutes to 1 hour, and from 1 hour to 4 hours.

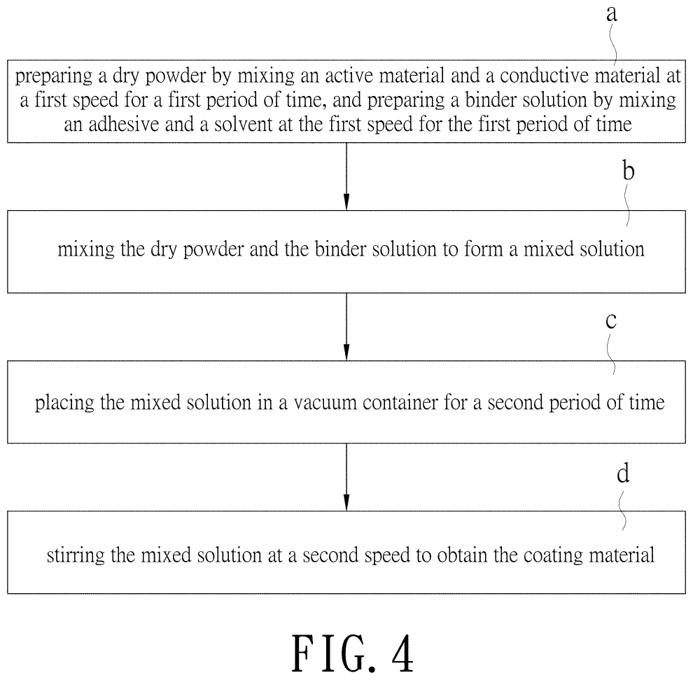

Referring to FIG. 4, a flow chart showing a second embodiment for a method for preparation of a coating material for a ternary lithium battery according to the present invention is also disclosed herein. The method comprises the steps of:

(a) preparing a dry powder by mixing 80-99 wt % of an active material and 1-20 wt % of a conductive material at a first speed for a first period of time, and preparing a binder solution by mixing 5-20 wt % of an adhesive and 80-95 wt % of a solvent at the first speed for the first period of time; preferably, the active material is selected from lithium cobaltate (LiCoO₂), nickel cobalt oxide or manganese cobalt oxide, the conductive material is carbon black, the adhesive is resin, and the solvent is selected from alcohol, acetone or toluene;

(b) mixing the dry powder and the binder solution to form a mixed solution;

(c) placing the mixed solution in a vacuum container for a second period of time; and

(d) stirring the mixed solution at a second speed to obtain the coating material. Preferably, the first speed is 50 rpm-2000 rpm, and the second speed is 1000 rpm-2000 rpm. Preferably, the first period of time and the second period of time respectively range from 1 hour to 4 hours and from 30 minutes to 2 hours.

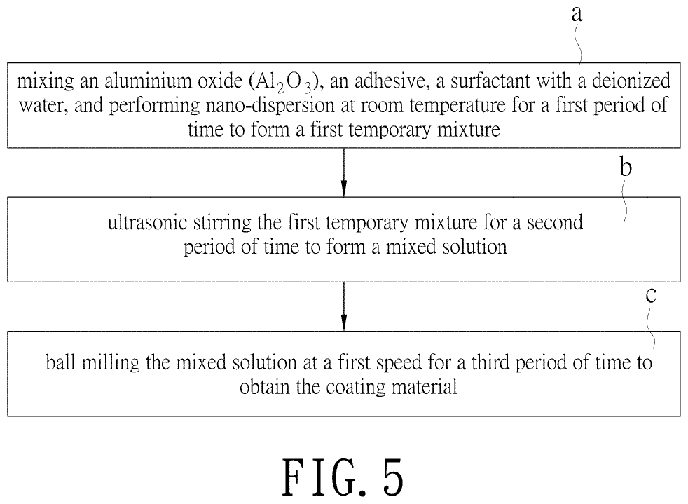

Referring to FIG. 5, a flow chart showing a third embodiment for a method for preparation of a coating material for a ternary lithium battery according to the present invention is also disclosed herein. The method comprises the steps of:

(a) mixing 35-40 wt % of an aluminium oxide (Al₂O₃), 0.1-1 wt % of an adhesive, 0.1-1 wt % of a surfactant with the remaining weight percent of a deionized water, and performing nano-dispersion at room temperature for a first period of time to form a first temporary mixture; preferably, the surfactant is disodium laureth sulfosuccinate (DLSS);

(b) ultrasonic stirring the first temporary mixture for a second period of time to form a mixed solution; and

(c) ball milling the mixed solution at a first speed for a third period of time to obtain the coating material.

Then, the coating material is coated on the isolation film (3) of the ternary lithium battery, dried at a first temperature for the first period of time, and further vacuum dried at the first temperature for a fourth period of time. Preferably, the first speed is 200 rpm-500 rpm. Preferably, the first period of time, the second period of time, the third period of time, and the fourth period of time respectively range from 30 minutes to 2 hours, from 12 hours to 24 hours, from 2 hours to 3 hours, and from 24 hours to 48 hours. Preferably, the first temperature is 60-120° C.

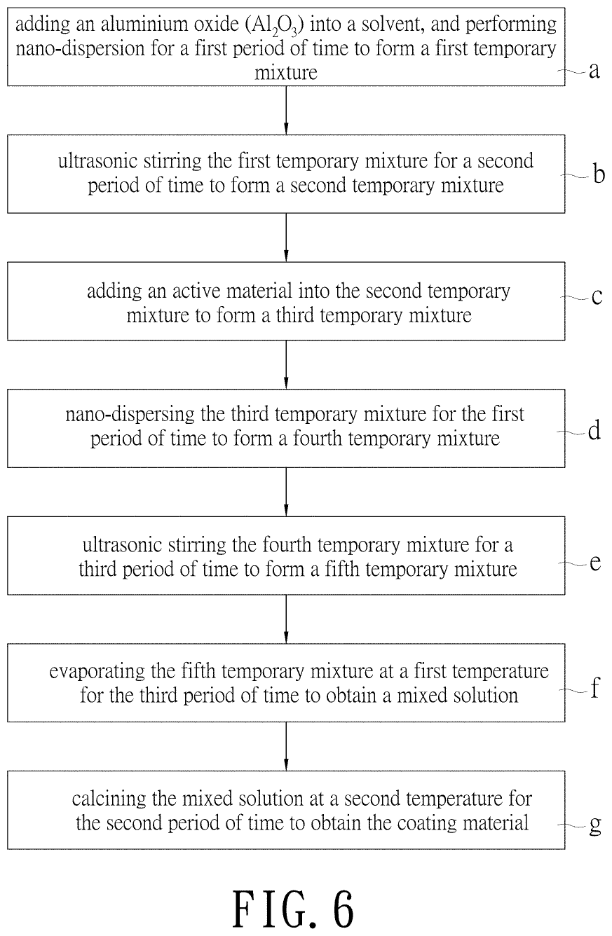

Referring to FIG. 6, a flow chart showing a fourth embodiment for a method for preparation of a coating material for a ternary lithium battery according to the present invention is also disclosed herein. The method comprises the steps of:

(a) adding 1-5 wt % of an aluminium oxide (Al₂O₃) into a solvent, and performing nano-dispersion for a first period of time to form a first temporary mixture; preferably, the solvent is selected from alcohol, acetone or toluene;

(b) ultrasonic stirring the first temporary mixture for a second period of time to form a second temporary mixture;

(c) adding 90-99.75 wt % of an active material into 0.25-10 wt % of the second temporary mixture to form a third temporary mixture; preferably, the active material is selected from lithium cobaltate (LiCoO₂), nickel cobalt oxide or manganese cobalt oxide;

(d) nano-dispersing the third temporary mixture for the first period of time to form a fourth temporary mixture;

(e) ultrasonic stirring the fourth temporary mixture for a third period of time to form a fifth temporary mixture;

(f) evaporating the fifth temporary mixture at a first temperature for the third period of time to obtain a mixed solution; and

(g) calcining the mixed solution at a second temperature for the second period of time to obtain the coating material. Preferably, the first temperature is 60-70° C., and the second temperature is 400-500° C. Preferably, the first period of time, the second period of time and the third period of time respectively range from 30 minutes to 2 hours, from 8 hours to 12 hours and from 12 hours to 24 hours.

Furthermore, the scope of the present invention may be further exemplified by the following embodiments, which are not intended to limit the scope of the invention.

In actual implementation, the method for preparation of a coating material for a ternary lithium battery of the present invention comprises four embodiments.

Referring to FIG. 1, the coating material prepared by the present invention can be coated on the positive electrode (1), the negative electrode (2) or the isolation film (3). For instance, the positive electrode (1) can be selected from lithium manganese dioxide (LiMnO₂), lithium cobaltate (LiCoO₂) or lithium nickel oxide (LiNiO₂), and the negative electrode (2) is selected from graphite material. Preferably, the isolation film (3) is selected from a single layer film or a multilayer film of polyethylene (PE) or polypropylene (PP), which has micro-porosity and porosity. The following four embodiments respectively illustrate the preparation processes and applications of the coating material.

### Embodiment One

Referring to FIG. 2 and FIG. 3, 80-99 wt % of lithium cobaltate (LiCoO₂), nickel cobalt oxide or manganese cobalt oxide and 1-20 wt % of carbon black are evenly mixed in a relatively dry environment at 50 rpm-200 rpm for 30 minutes to 2 hours to form a dry powder. In addition, 5-20 wt % of resin used as an adhesive is added into 80-95 wt % of alcohol, acetone or toluene as a solvent at 50 rpm-200 rpm for 30 minutes to 2 hours to form a binder solution. The mixed solution is prepared by repeatedly mixing the dry powder and the binder solution. Specifically, the mixed solution is prepared by the following steps of: mixing about 16.7 volume percent of the dry powder with 25 volume percent of the adhesive at 1000 rpm-2000 rpm for 30 minutes to 2 hours to form a first temporary mixture; mixing the first temporary mixture with about 16.7 volume percent of the dry powder at 1000 rpm-2000 rpm for 30 minutes to 2 hours to form a second temporary mixture; mixing the second temporary mixture with 25 volume percent of the binder solution at 1000 rpm-2000 rpm for 1 hour to 4 hours to form a third temporary mixture; mixing the third temporary mixture with about 16.7 volume percent of the dry powder at 1000 rpm-2000 rpm for 30 minutes to 2 hours to form a fourth temporary mixture; mixing the fourth temporary mixture with about 16.7 volume percent of the dry powder at 1000 rpm-2000 rpm for 30 minutes to 2 hours to form a fifth temporary mixture; mixing the fifth temporary mixture with 25 volume percent of the binder solution at 1000 rpm-2000 rpm for 1 hour to 4 hours to form a sixth temporary mixture; mixing the sixth temporary mixture with about 16.7 volume percent of the dry powder at 1000 rpm-2000 rpm for 30 minutes to 2 hours to form a seventh temporary mixture; mixing the seventh temporary mixture with about 16.7 volume percent of the dry powder at 1000 rpm-2000 rpm for 30 minutes to 2 hours to form an eighth temporary mixture; and mixing the eighth temporary mixture with 25 volume percent of the binder solution at 1000 rpm-2000 rpm for 1 hour to 4 hours so as to obtain the mixed solution.

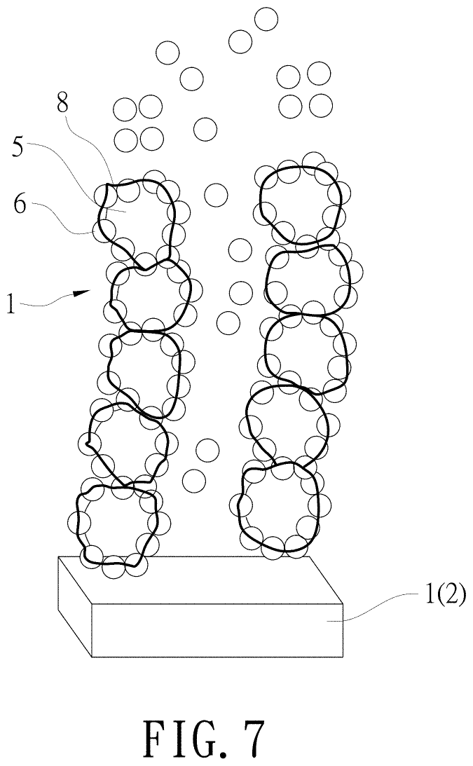

After preparation, the mixed solution is placed in a vacuum container for 15 minutes to 1 hour, and then nano-dispersed to form the coating material. Referring to FIG. 7, a first schematic diagram showing a coating material in use according to the present invention is disclosed. The coating material (7) is a slurry to be coated on a positive electrode (1) or a negative electrode (2) of the ternary lithium battery, preferably coated on the positive electrode (1). The molecules of each active material (5) are connected to plural molecules of the conductive material (6), and the molecules of the conductive material (6) are connected to each other by a ring-shaped connecting unit (8), so that the coating material (7) has plural ring-shaped three-dimensional structures and can prevent aggregation.

### Embodiment Two

Referring to FIG. 4, 80-99 wt % of lithium cobaltate (LiCoO₂), nickel cobalt oxide or manganese cobalt oxide and 1-20 wt % of carbon black are evenly mixed in a relatively dry environment at 50 rpm-2000 pin for 30 minutes to 2 hours to form a dry powder. In addition, 5-20 wt % of resin used as an adhesive is added into 80-95 wt % of alcohol, acetone or toluene as a solvent at 50 rpm-200 rpm for 1 hour to 4 hours to form a binder solution. Then, the dry powder and the binder solution are mixed to form a mixed solution. Finally, the mixed solution is placed in a vacuum container for 30 minutes to 2 hours, and then stirred at 1000 rpm-2000 rpm to obtain the coating material. As shown in FIG. 7, the coating material (7) is a slurry to be coated on a positive electrode (1) or a negative electrode (2) of the ternary lithium battery, preferably coated on the negative electrode (2). The molecules of each active material (5) are connected to plural molecules of the conductive material (6), and the molecules of the conductive material (6) are connected to each other by a ring-shaped connecting unit (8), so that the coating material (7) has plural ring-shaped three-dimensional structures and can prevent aggregation.

### Embodiment Three

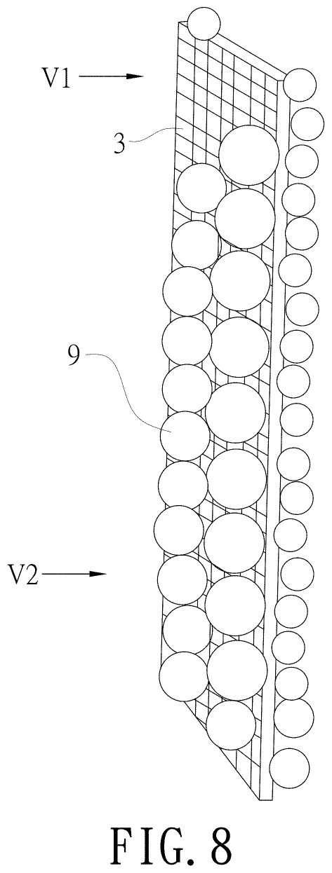

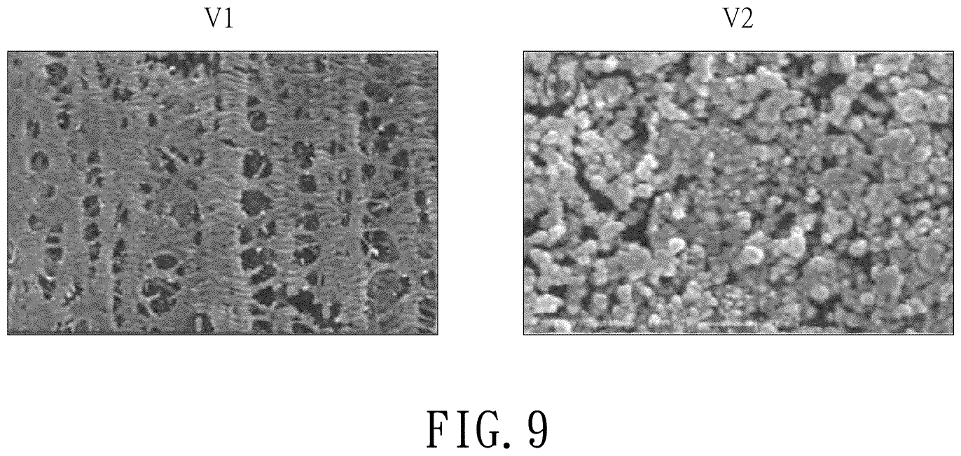

Referring to FIG. 5, 35-40 wt % of the aluminium oxide (Al₂O₃), 0.1-1 wt % of the adhesive, 0.1-1 wt % of the surfactant are added into the remaining weight percent of the deionized water at room temperature for 30 minutes to 2 hours to form a first temporary mixture. The surfactant is disodium laureth sulfosuccinate (DLSS). Then, the first temporary mixture is ultrasonic stirred for 12 hours to 24 hours to form a mixed solution. Finally, the mixed solution is ball milled at 200 rpm-500 rpm for 2 hours to 3 hours to obtain the coating material. In such a case, the coating material (9) can be coated on an isolation film (3) of the ternary lithium battery, dried at 60-120° C. for 30 minutes to 2 hours, and further vacuum dried at 60-120° C. for 24 hours to 48 hours. Referring to FIG. 8, a second schematic diagram showing a coating material in use according to the present invention is disclosed. The coating material (9) is coated on an isolation film (3) and evenly distributed on a surface of the isolation film (3) to effectively improve heat resistance, thereby improving safety and service life of the ternary lithium battery. Referring to FIG. 9, an electron microscopic diagram showing a coating material according to the present invention is disclose. V1 and V2 are observed by an electron microscope. V1 shows that the surface is not covered with the coating material (9), and V2 shows that the surface is covered with the coating material (9). The surface of the isolation film (3) at V2 is clearly distributed with plural particles of the coating material (9). Aluminum oxide (Al₂O₃) has characteristics of high temperature resistance, good wettability, self-shutdown, and low self-discharge rate, so it can effectively increase cycle life and improve safety. Specifically, aluminum oxide (Al₂O₃) can withstand high temperatures of above 180° C., and has good liquid absorption and liquid retention capabilities. It can effectively insulate heat and suppress the temperature rise of the ternary lithium battery during use, and can also reduce the risk of melting of the isolation film (3) due to excessive temperature.

### Embodiment Four

Referring to FIG. 6, an aluminium oxide (Al₂O₃) is added into a solvent selected from alcohol, acetone or toluene, and nano-dispersed for 30 minutes to 2 hours to form a first temporary mixture comprising 1-5 wt % of the aluminium oxide. Then, the first temporary mixture is ultrasonic stirred for 8 hours to 12 hours to form a second temporary mixture. The active material selected from lithium cobaltate (LiCoO₂), nickel cobalt oxide or manganese cobalt oxide is added into the second temporary mixture to form a third temporary mixture. Specifically, the third temporary mixture comprises 90-99.75 wt % of the active material and 0.25-10 wt % of the second temporary mixture. The third temporary mixture is nano-dispersed for 30 minutes to 2 hours to form a fourth temporary mixture. Next, the fourth temporary mixture for a third period of time to form a fifth temporary mixture is ultrasonic stirred for 12 hours to 24 hours to form a fifth temporary mixture. The fifth temporary mixture is evaporated at 400-500° C. for 12 hours to 24 hours to obtain a mixed solution. Finally, the mixed solution is calcined at 400-500° C. for 8 hours to 12 hours to obtain the coating material. The coating material can be coated on a positive electrode (1) to improve heat resistance, safety and service life of the ternary lithium battery. Furthermore, the coating material to which the positive electrode (1) is attached can be used to modify the surface of the positive electrode (1) so as to maintain the initial capacity of the active material, prevent the metal ions from being dissolved in the electrolyte, suppress side reactions, and thereby improve the capacity retention rate of the positive electrode (1).

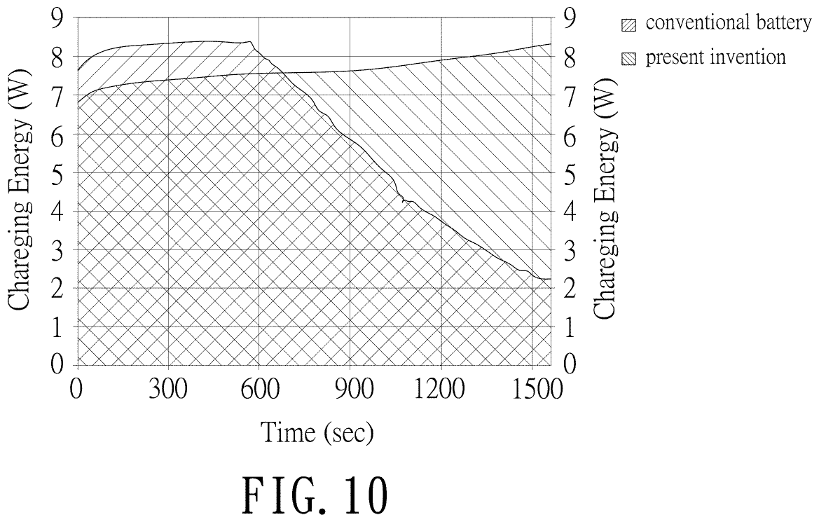

Referring to FIG. 10, a comparison of charging energy between a conventional battery and a ternary lithium battery coated with the coating material of the present invention is revealed. This analysis is performed in the case of low-magnification charging (≤2 C). Compared with the charging energy of the conventional battery, the ternary lithium battery coated with the present invention has higher charging energy and charging speed at the same comparison time.

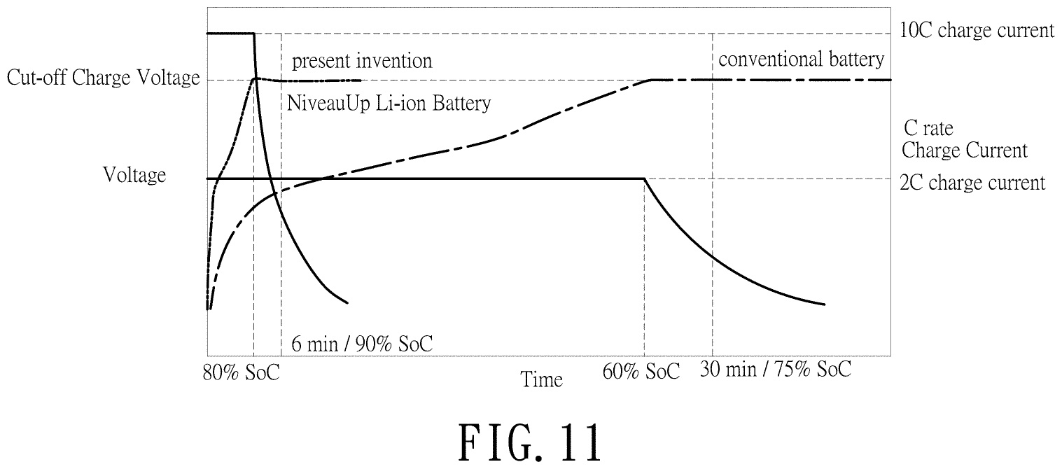

Referring to FIG. 11, when the ternary lithium battery coated with the present invention is charged at a high magnification (10C), 90% of the state of charge (SoC) can be achieved in only 6 minutes, which means that it only needs to be charged for 6 minutes to reach 90% of the electricity. However, the conventional battery cannot be charged at the high magnification (10C). When the conventional battery is charged at low-magnification (2 C), it takes 30 minutes to reach 75% of the state of charge (SoC). Therefore, the invention not only has better electric capacity, but also achieves high performance in charge and discharge efficiency and high performance at high magnification.

According to the above description, in comparison with the traditional technique, the present invention has the advantages as following:

1. The present invention uses the active material, the conductive material and the adhesive to prepare the coating material for coating on the positive electrode or the negative electrode of the ternary lithium battery to form plural ring-shaped three-dimensional structures, which prevent aggregation and improve electrode performance including capacity, charge and discharge efficiency and performance at high magnification.

2. The coating material prepared by aluminum oxide (Al₂O₃) can be coated on an isolation film or a positive electrode to improve heat resistance of the ternary lithium battery, which prevents short circuit, improves safety and service life of the ternary lithium battery.

3. The improved coating material of the present invention can be applied in the field of electric vehicles to improve the endurance and performance of the electric vehicles.

What is claimed is:

1. A method for preparation of a coating material for a ternary lithium battery, comprising the steps of:
(a) preparing a dry powder by mixing 80-99 wt % of an active material and 1-20 wt % of a conductive material at a first speed for a first period of time, and preparing a binder solution by mixing 5-20 wt % of an adhesive and 80-95 wt % of a solvent at the first speed for the first period of time;
(b) mixing the dry powder and the binder solution at a second speed to form a mixed solution;
(c) placing the mixed solution in a vacuum container for a second period of time; and
(d) nano-dispersing the mixed solution to obtain the coating material.

2. The method for preparation of a coating material for a ternary lithium battery as claimed in claim 1, wherein the active material is selected from lithium cobaltate (LiCoO₂), nickel cobalt oxide or manganese cobalt oxide, and wherein the conductive material is carbon black.

3. The method for preparation of a coating material for a ternary lithium battery as claimed in claim 1, wherein the adhesive is resin, and wherein the solvent is selected from alcohol, acetone or toluene.

4. The method for preparation of a coating material for a ternary lithium battery as claimed in claim 1, wherein the second period of time ranges from 15 minutes to 1 hour.

5. The method for preparation of a coating material for a ternary lithium battery as claimed in claim 1, wherein the mixed solution in the step (b) is prepared by:
mixing about 16.7 volume percent of the dry powder with 25 volume percent of the adhesive at the second speed for the first period of time to form a first temporary mixture;
mixing the first temporary mixture with about 16.7 volume percent of the dry powder at the second speed for the first period of time to form a second temporary mixture;
mixing the second temporary mixture with 25 volume percent of the binder solution at the second speed for a third period of time to form a third temporary mixture;
mixing the third temporary mixture with about 16.7 volume percent of the dry powder at the second speed for the first period of time to form a fourth temporary mixture;
mixing the fourth temporary mixture with about 16.7 volume percent of the dry powder at the second speed for the first period of time to form a fifth temporary mixture;
mixing the fifth temporary mixture with 25 volume percent of the binder solution at the second speed for the third period of time to form a sixth temporary mixture;
mixing the sixth temporary mixture with about 16.7 volume percent of the dry powder at the second speed for the first period of time to form a seventh temporary mixture;
mixing the seventh temporary mixture with about 16.7 volume percent of the dry powder at the second speed for the first period of time to form an eighth temporary mixture; and
mixing the eighth temporary mixture with 25 volume percent of the binder solution at the second speed for the third period of time to obtain the mixed solution.

6. The method for preparation of a coating material for a ternary lithium battery as claimed in claim 5, wherein the first speed and the second speed are 50 rpm-200 rpm and 1000 rpm-2000 rpm, respectively, and wherein the first period of time and the second period of time respectively range from 30 minutes to 2 hours and from 1 hour to 4 hours.

7. A method for preparation of a coating material for a ternary lithium battery, comprising the steps of:
(a) preparing a dry powder by mixing 80-99 wt % of an active material and 1-20 wt % of a conductive material at a first speed for a first period of time, and preparing a binder solution by mixing 5-20 wt % of an adhesive and 80-95 wt % of a solvent at the first speed for the first period of time;
(b) mixing the dry powder and the binder solution to form a mixed solution;
(c) placing the mixed solution in a vacuum container for a second period of time; and
(d) stirring the mixed solution at a second speed to obtain the coating material.

8. The method for preparation of a coating material for a ternary lithium battery as claimed in claim 7, wherein the active material is selected from lithium cobaltate (LiCoO₂), nickel cobalt oxide or manganese cobalt oxide, and wherein the conductive material is carbon black.

9. The method for preparation of a coating material for a ternary lithium battery as claimed in claim 7, wherein the adhesive is resin.

10. The method for preparation of a coating material for a ternary lithium battery as claimed in claim 7, wherein the solvent is selected from alcohol, acetone or toluene, wherein the first speed and the second speed are 50 rpm-2000 rpm and 1000 rpm-2000 rpm, respectively, and wherein the first period of time and the second period of time respectively range from 1 hour to 4 hours and from 30 minutes to 2 hours.

11. A method for preparation of a coating material for a ternary lithium battery, comprising the steps of:
(a) mixing an aluminium oxide (Al₂O₃), an adhesive, a surfactant with a deionized water, and performing nano-dispersion at room temperature for a first period of time to form a first temporary mixture;
(b) ultrasonic stirring the first temporary mixture for a second period of time to form a mixed solution; and
(c) ball milling the mixed solution at a first speed for a third period of time to obtain the coating material.

12. The method for preparation of a coating material for a ternary lithium battery as claimed in claim 11, wherein the step (a) is mixing 35-40 wt % of the aluminium oxide (Al₂O₃), 0.1-1 wt % of the adhesive, 0.1-1 wt % of the surfactant with the remaining weight percent of the deionized water.

13. The method for preparation of a coating material for a ternary lithium battery as claimed in claim 11, wherein the surfactant is disodium laureth sulfosuccinate (DLSS).

14. The method for preparation of a coating material for a ternary lithium battery as claimed in claim 11, wherein the first speed is 200 rpm-500 rpm, and wherein the first period of time, the second period of time and the third period of time respectively range from 30 minutes to 2 hours, from 12 hours to 24 hours and from 2 hours to 3 hours.

15. The method for preparation of a coating material for a ternary lithium battery as claimed in claim 11, wherein the coating material is coated on an isolation film of the ternary lithium battery, dried at a first temperature for the first period of time, and further vacuum dried at the first temperature for a fourth period of time.

16. The method for preparation of a coating material for a ternary lithium battery as claimed in claim 15, wherein the first temperature is 60-120° C., and wherein the fourth period of time ranges from 24 hours to 48 hours.

17. A method for preparation of a coating material for a ternary lithium battery, comprising the steps of:
(a) adding an aluminium oxide (Al₂O₃) into a solvent, and performing nano-dispersion for a first period of time to form a first temporary mixture;
(b) ultrasonic stirring the first temporary mixture for a second period of time to form a second temporary mixture;
(c) adding an active material into the second temporary mixture to form a third temporary mixture;
(d) nano-dispersing the third temporary mixture for the first period of time to form a fourth temporary mixture;
(e) ultrasonic stirring the fourth temporary mixture for a third period of time to form a fifth temporary mixture;
(f) evaporating the fifth temporary mixture at a first temperature for the third period of time to obtain a mixed solution; and
(g) calcining the mixed solution at a second temperature for the second period of time to obtain the coating material.

18. The method for preparation of a coating material for a ternary lithium battery as claimed in claim 17, wherein the solvent is selected from alcohol, acetone or toluene, and wherein the active material is selected from lithium cobaltate (LiCoO₂), nickel cobalt oxide or manganese cobalt oxide.

19. The method for preparation of a coating material for a ternary lithium battery as claimed in claim 17, wherein the first temperature and the second temperature are 60-70° C. and 400-500° C., respectively, and wherein the first period of time, the second period of time and the third period of time respectively range from 30 minutes to 2 hours, from 8 hours to 12 hours and from 12 hours to 24 hours.

20. The method for preparation of a coating material for a ternary lithium battery as claimed in claim 17, wherein the first temporary mixture comprises 1-5 wt % of the aluminium oxide, and wherein the third temporary mixture comprises 90-99.75 wt % of the active material and 0.25-10 wt % of the second temporary mixture.
